(19) United States
(12) Patent Application Publication
(10) Pub. No.: US 2025/0079649 A1
(43) Pub. Date: Mar. 6, 2025

(54) ELECTRODE ASSEMBLY STRUCTURE FOR SECONDARY BATTERY, AND SECONDARY BATTERY INCLUDING THE SAME

(71) Applicant: SK On Co., Ltd., Seoul (KR)

(72) Inventors: Bo Kyung KO, Daejeon (KR); Seung Hun LEE, Daejeon (KR)

(21) Appl. No.: 18/795,183

(22) Filed: Aug. 6, 2024

(30) Foreign Application Priority Data
Aug. 30, 2023 (KR) 10-2023-0114700
May 10, 2024 (KR) 10-2024-0061706

(51) Int. Cl. H01M 50/533; H01M 50/538

(52) U.S. Cl. CPC H01M 50/533; H01M 50/538

(57) ABSTRACT

An electrode assembly structure for a secondary battery includes an electrode assembly stack in which two or more electrode assemblies with electrode tabs extending in one direction are stacked and a current collecting member disposed on a first end portion of the electrode assembly stack and including a slit through which the electrode tab passes, wherein the electrode tab passes through the slit, and the electrode tab and the current collecting member are electrically connected.

### CROSS-REFERENCE TO RELATED APPLICATION(S)

This patent document claims the priority and benefits of Korean Patent Application Nos. 10-2023-0114700 filed on Aug. 30, 2023 and 10-2024-0061706 filed on May 10, 2024, the disclosures of which are incorporated herein by reference in their entireties.

### TECHNICAL FIELD

The present disclosure relates to an electrode assembly structure for a secondary battery and a secondary battery including the same.

### BACKGROUND

As interest in environmental issues has grown recently, exhaust gases emitted from vehicles using fossil fuels, such as gasoline or diesel, have been identified as one of the main causes of air pollution, and research into electric vehicles (EVs), hybrid electric vehicles (HEV), etc., has been conducted extensively as alternatives.

In addition, lithium secondary batteries having a high discharge voltage and output stability have been mainly used as a power source for electric vehicles (EV), hybrid electric vehicles (HEV), etc. In addition, the need for high-energy secondary batteries having high energy density and capacity has increased.

Accordingly, in order to implement high-energy secondary batteries, technology for manufacturing secondary batteries by stacking a large number of positive electrodes and negative electrodes or by stacking a large number of electrode assemblies including the positive electrodes and negative electrodes has been actively promoted.

### SUMMARY

The present disclosure may be implemented in some embodiments to provide an electrode assembly structure for a secondary battery having high energy density and capacity.

The present disclosure may be implemented in some embodiments to provide a secondary battery having improved energy density and capacity.

In some embodiments of the present disclosure, an electrode assembly structure for a secondary battery includes: an electrode assembly stack in which two or more electrode assemblies with electrode tabs extending in one direction are stacked; and a current collecting member disposed on a first end portion of the electrode assembly stack and including a slit through which the electrode tab passes, wherein the electrode tab passes through the slit, and the electrode tab and the current collecting member are electrically connected.

The electrode tab may be in contact with one surface of the current collecting member.

The electrode tab may include a bent portion bent toward one surface of the current collecting member.

The electrode tab may be bent in a direction, perpendicular to an electrode tab extension direction.

The two or more electrode tabs may be bent in the same direction.

The electrode tab may be bent, and a distal end portion thereof may contact one surface of the current collecting member.

The one electrode tab may pass through one slit.

The two or more slits may be spaced apart from each other.

The two or more slits may be isolated from each other, and at least one of the two or more slits may be closed on all four sides.

The two or more slits may be isolated from each other, and at least one of the slits may have at least one side thereof open.

The electrode assembly stack may be a stack of three or more electrode assemblies, the current collecting member may have three or more slits, and one electrode tab may pass through one slit.

The electrode tab may have a length of 8 to 30 mm.

The electrode assembly stack may further include a current collecting member having a polarity opposite to a polarity of the current collecting member on a second end portion, facing the first end portion.

In some embodiments of the present disclosure, a secondary battery includes the electrode assembly structure for a secondary battery according to one of the embodiments described above; and a battery case accommodating the electrode assembly structure.

### BRIEF DESCRIPTION OF DRAWINGS

Certain aspects, features, and advantages of the present disclosure are illustrated by the following detailed description with reference to the accompanying drawings.

FIGS. 1 to 3 are perspective views schematically illustrating an electrode assembly stack and an electrode assembly structure according to a manufacturing process of an electrode assembly structure for a secondary battery according to an embodiment.

FIG. 4 is a cross-sectional view illustrating the electrode assembly structure obtained in FIG. 3, taken along line A-A′.

FIG. 5 is a plan view schematically illustrating an example of a current collecting member including three slits having through-regions, through which electrode tabs pass, closed on all sides according to an embodiment of the present disclosure.

FIG. 6 is a plan view schematically illustrating an example of a current collecting member including three slits among which one slit is open on one side according to an embodiment of the present disclosure.

FIG. 7 is a plan view schematically illustrating an example of a current collecting member including three slits among which two slits are open on one side according to an embodiment of the present disclosure.

FIG. 8 is a plan view schematically illustrating an example of a current collecting member including three slits open on the same side according to an embodiment of the present disclosure.

FIG. 9 is a plan view schematically illustrating an example of a current collecting member including three slits open on different sides.

FIG. 10 is a cross-sectional view schematically illustrating an electrode assembly structure for a secondary battery in which current collecting members are disposed on both ends of an electrode assembly stack according to an embodiment of the present disclosure.

### DETAILED DESCRIPTION

The present disclosure will be described in detail with reference to the accompanying drawings. However, this is merely illustrative and the present disclosure is not limited to the specific embodiments described by way of example.

While such terms as “first,” “second,” etc., may be used to describe various components, such components must not be limited to the above terms. The above terms are used only to distinguish one component from another.

An expression used in the singular encompasses the expression of the plural, unless it has a clearly different meaning in the context.

In the present specification, it is to be understood that the terms, such as “including,” “having,” and “comprising” are intended to indicate the existence of the features or components disclosed in the specification, and are not intended to preclude the possibility that one or more other features or components may exist or may be added.

Sizes of components in the drawings may be exaggerated for convenience of description. In other words, since sizes and thicknesses of components in the drawings are arbitrarily illustrated for convenience of description, the following embodiments are not limited thereto.

When a certain embodiment may be implemented differently, a specific process order may be performed differently from the described order. For example, two consecutively described processes may be performed substantially at the same time or performed in an order opposite to the described order.

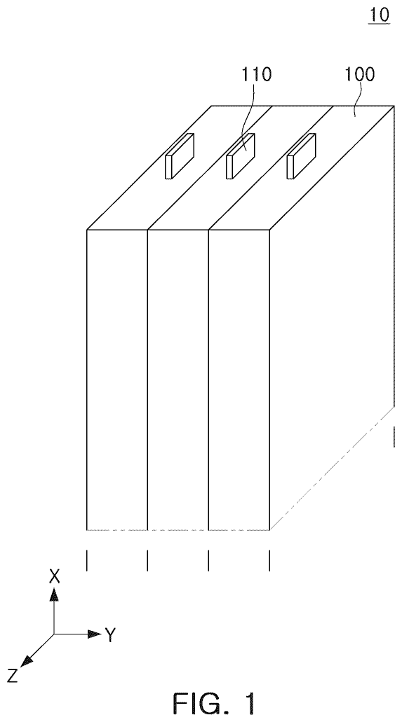

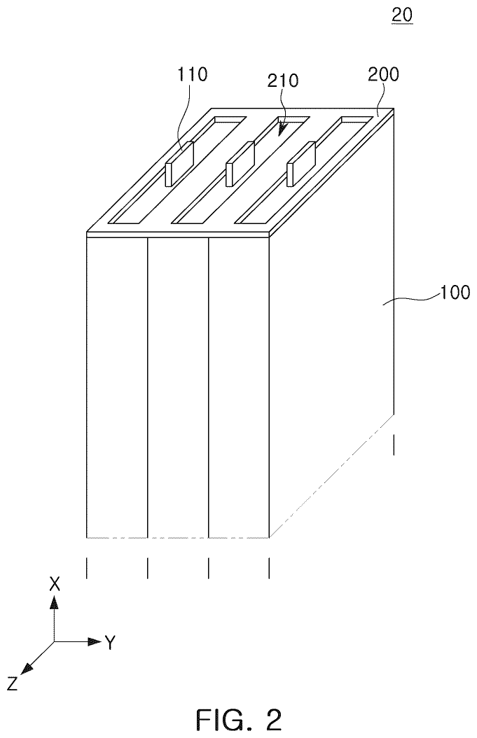

FIGS. 1 to 3 are perspective views illustrating a method of manufacturing an electrode assembly structure for a secondary battery according to an embodiment. In addition, FIG. 4 is a cross-sectional view taken along line A-A′ of the perspective view of FIG. 3.

Referring to FIGS. 1 to 3, a method of manufacturing an electrode assembly structure 20 for a secondary battery according to an embodiment may include sequentially stacking a plurality of electrode assemblies 100, disposing a current collecting member 200 on the electrode assemblies 100, and bending an electrode tab 110 disposed at one end of the electrode assembly 100 toward one surface of the current collecting member 200 to connect the electrode tab 110 to the current collecting member 200.

FIGS. 1 to 3 illustrate an electrode assembly stack 10 in which three electrode assemblies 100 are sequentially stacked in a Y-axis direction, which is a thickness direction of the electrode assembly 100. However, the present disclosure is not limited thereto, and the electrode assembly stack 10 may include two or more electrode assemblies 100 being sequentially stacked or four or more electrode assemblies 100 being sequentially stacked.

FIG. 1 illustrates a perspective view illustrating a single electrode assembly stack 10 formed by stacking three electrode assemblies 100. Referring to FIG. 1, two or more electrode assemblies 100 may be stacked to form the electrode assembly stack 10, and the electrode tab 110 of the electrode assembly 100 may extend in one direction. Specifically, a plurality of electrode assemblies 100 may be sequentially stacked in a direction (the Y-direction), perpendicular to a length direction (an X-direction) of the electrode assembly 100, that is, in the thickness direction of the electrode assembly 100 to form an electrode assembly stack 10.

Each electrode assembly 100 constituting the electrode assembly stack 10 may include a negative electrode, a positive electrode, and a separator. In detail, the electrode assembly 100 may include one or more negative electrodes and one or more positive electrodes disposed with a separator interposed therebetween. That is, the electrode assembly 100 may have a stacked structure of a positive electrode/separator/negative electrode, and a plurality of positive electrodes and a plurality of negative electrodes may be alternately stacked.

In an embodiment, the electrode assembly 100 may be a jelly-roll (wound type) electrode assembly having a structure in which the positive electrodes and the negative electrodes in the form of a long sheet are wound with the separator interposed therebetween or a stack-type electrode assembly in which a plurality of positive electrodes and a plurality of negative electrodes cut into units of a predetermined size are sequentially stacked with a separator interposed therebetween.

The positive electrode and the negative electrode may have a structure including a mixture layer on at least one surface of a current collector. The mixture layer may include, but is not limited to, an active material and a binder, may include a conductive material, if necessary, and may further include additives, such as a dispersant.

Meanwhile, the positive electrode and the negative electrode may include an uncoated portion on which the mixture layer is not formed at one end of the current collector in order to electrically connect a plurality of electrodes of the same type included in the electrode assembly 100 to each other.

The uncoated portion may be cut into a predetermined shape to form an uncoated portion tab. That is, the uncoated portion tab may be formed at one end of the positive electrode and one end of the negative electrode.

The uncoated portion tab may include a positive electrode uncoated portion tab formed at one end of the positive electrode and a negative electrode uncoated portion tab formed at one end of the negative electrode.

A plurality of the uncoated portion tabs of the same polarity may be welded to be coupled to form the electrode tab 110. Accordingly, the positive electrodes may be connected to each other and the negative electrodes may be connected to each other through the electrode tab 110.

The electrode tab 110 may be formed at one end of the electrode assembly 100. The electrode tab 110 may be formed at a first end of the electrode assembly 100 in the X-direction and extend in the X-direction.

The electrode tab 110 may include a positive electrode tab to which the positive electrode uncoated portion tabs are coupled and a negative electrode tab to which the negative electrode uncoated portion tabs are coupled. In an embodiment, the positive electrode tab may be formed at one end of the electrode assembly 100 in the X-direction, and the negative electrode tab may be formed at the other end opposite to one end of the electrode assembly 100 in the X-direction.

FIGS. 1 to 3 illustrate that the electrode tab 110 is formed only at the first end of the electrode assembly 100 for convenience of description, but without being limited thereto, the electrode tab 110 may also be formed at the other end (a second end) opposite to the first end of the electrode assembly 100 in the X-direction.

A current collecting member may be disposed on a first end portion of the electrode assembly stack 10. FIG. 2 is a perspective view schematically illustrating an example of an electrode assembly structure 20 in which a current collecting member including a slit 210 through which the electrode tab 110 may pass is disposed on a first end portion of the electrode assembly stack 10 in which two or more electrode assemblies 100 in which the electrode tab 110 extends in one direction on one end portion (a first end portion) of the electrode assembly stack 10 are stacked.

The current collecting member 200 may have a plurality of slits 210. In an embodiment, the current collecting member 200 may have two or more slits 210 and may have three or more slits 210.

The slits 210 may be formed to be spaced apart from each other in the Y-direction.

In an embodiment, the slits 210 may be provided in the current collecting member 200 at substantially equal intervals from each other. The electrode tab 110 of the electrode assembly 100 may pass through the slit 210. One electrode tab 110 may pass through the slit 210, and two or more electrode tabs 110 may pass through one slit 210.

Specifically, the current collecting member 200 may be disposed on the electrode assembly stack 100 so that the electrode tab 110 is located within the slit 210. Accordingly, the electrode tab 110 may be exposed to the outside of the current collecting member 200 in the direction in which the electrode tab 110 extends through the slit 210.

The electrode tab 110 may pass through the slit 210, and the electrode tab 110 and the current collecting member may be in contact and electrically connected. The electrical connection between the electrode tab 110 and the current collecting member is not particularly limited, but referring to FIG. 3, the electrode tab 110 may be bent toward one surface of the current collecting member 200 to come into contact with the current collecting member 200. Accordingly, the electrode assemblies 100 may be electrically connected to each other through the current collecting member 200.

The electrode tab 110 may include a bent portion 120 bent toward one surface of the current collecting member 200.

In an embodiment, the electrode tab 110 may be bent toward one surface of the current collecting member 200 to contact one surface of the current collecting member 220. The bending is not particularly limited and the electrode tab 110 may be bent once or multiple times. Accordingly, the electrode tab 110 may include at least one bent portion 120.

For example, as illustrated in FIG. 3, the electrode tab 110 may be bent once so that an electrode tab distal end portion 130 may contact one surface of the current collecting member, and electrical contact may be secured more stably.

In an embodiment, the electrode tab 110 may be bent in the Y-direction. Specifically, the electrode tab 110 may be bent in the Y-direction, perpendicular to the X-direction, which is an electrode tab extension direction in which the electrode tab 110 extends. Accordingly, the electrode tab 110 is bent once at the bent portion 120, so that the electrode tab distal end portion 130 may contact the current collecting member.

In an embodiment, each electrode tab 110 may be bent in substantially the same direction as illustrated in FIG. 3. Accordingly, since the electrode tabs 110 are bent in substantially the same direction, they may not overlap each other. In addition, since the electrode tabs 110 may be bent simultaneously, the equality of a bending process may be improved.

Meanwhile, when two or more electrode tabs 110 pass through one slit 210, the electrode tabs 110 may be bent in a direction to contact the current collecting member. Therefore, the bending direction of the electrode tab 110 may not necessarily have to be the same, and the electrode tabs 110 may be bent in a direction ensuring contact between the electrode tab 110 and the current collecting member and may be bent in opposite directions.

In an embodiment, after the electrode tab 110 is bent, the electrode tab 110 and the current collection member 200 may be welded to bond the electrode tab 110 to one surface of the current collection member 220.

As a result, manufacturing of the electrode assembly structure 20 for a secondary battery may be completed.

Hereinafter, the electrode assembly structure 20 for a secondary battery according to an embodiment of the present disclosure is described with reference to FIGS. 3 and 4.

Referring to FIGS. 3 and 4, according to an embodiment of the present disclosure, the electrode assembly structure 20 for a secondary battery including the electrode assembly stack 10 in which two or more electrode assemblies 100 are stacked and including the current collecting member 200 disposed on the electrode assembly stack 10 and including the slit 210 through which the electrode tab of the electrode assembly 100 may pass through is provided. An example of the electrode assembly structure 20 according to the present disclosure is illustrated in FIG. 3, and FIG. 4 is a cross-sectional view schematically illustrating a cross-sectional structure of the electrode assembly 20 of FIG. 3 taken along line A-A′.

The electrode assembly stack 10 may include two or more electrode assemblies 100, and the electrode assemblies 100 may be stacked in the thickness direction (the X-direction) of the electrode assembly 100. Each electrode assembly 100 may include the electrode tab 110 disposed at one end portion (the first end portion), and the electrode tab 110 may extend in one direction.

The electrode tab 110 may pass through the slit 210, and the electrode tab 110 and the current collector 200 may be in contact and electrically connected. In addition, in an embodiment, the electrode tab 110 may contact one surface of the current collecting member 200.

The electrode tab 110 may include the bent portion 120 and may be bent at the bent portion 120 to contact one surface of the current collecting member 200. More specifically, the electrode tab 110 may be bent toward one surface of the current collecting member at the bent portion 120, so that the electrode tab distal end portion 130 may contact one surface of the current collecting member.

The electrode tab 110 may have a short length. Specifically, in an embodiment, the electrode tab 110 may have a length of about 8 to about 30 mm. If the electrode tab 110 has a length less than about 8 mm, when the electrode tab 110 is bent, the length of the electrode tab 110 may be short and the electrode tab 110 may not be connected to one surface of the current collecting member 200. If the electrode tab 110 has a length more than about 30 mm, the area of the mixture layer in the current collector may decrease and the area of the uncoated portion in the current collector may increase, and as a result, energy density and capacity of the electrode assembly structure 20 for a secondary battery may be reduced. Accordingly, the electrode tab 110 may have a short length within the aforementioned range to be connected to one surface of the current collector 200 and the electrode assembly structure 20 for a secondary battery may have high energy density and capacity. The energy density and capacity of the electrode assembly structure 20 for a secondary battery depending on the length of the electrode tab 110 are described in detail below.

In an embodiment, the electrode tab 110 may include, but is not limited to, one bent portion 120 or two or more bent portions 120. More specifically, the electrode tab 110 may include one bent portion 120. When the number of bent portions 120 is two or more, the length of the electrode tab 110 may increase, and accordingly, the energy density and capacity of the electrode assembly structure 20 for a secondary battery may decrease.

In an embodiment, the electrode tab 110 may be bent in a direction, perpendicular to the direction in which the electrode tab 110 extends, that is, in the Y-direction. The bending direction of the electrode tab 110 is not particularly limited as long as the electrode tab 10 may come into contact with the current collecting member, but, for example, the electrode tab 110 may be bent in substantially the same direction.

In an embodiment, the slit 210 may have a shape extending in a Z-direction, perpendicular to the X-direction and the Y-direction. In addition, the length of the slit 210 in the Z-direction may be greater than the length of the slit 210 in the Y-direction.

More specifically, as illustrated in FIG. 3, the length of the slit 210 in the Z-direction may be greater than the length of the electrode tab 110 in the X-direction and may be less than the length of the electrode assembly 100 in the Z-direction. In addition, the length of the slit 210 in the Y-direction may be greater than the thickness (the length in the Y-direction) of the electrode tab 110 and may be less than the thickness (the length in the Y-direction) of the electrode assembly 100.

In an embodiment, the electrode assembly structure 20 for a secondary battery of the present disclosure may include three or more stacked electrode assemblies 100, and the current collecting member 200 may include three or more slits 210. One electrode tab 110 may pass through one slit 210.

As described above, the current collecting member 200 may have a plurality of slits 210, the electrode tab 110 may include the bent portion 120 passing through the slit 210 to be in contact with and electrically connected to the current collecting member 200 and bent toward one surface of the current collecting member 200, and the electrode tab distal end portion 130 bent by the bent portion 120 may contact the current collecting member 200.

That is, the electrode tab 110 may pass through the slit 210 to be connected to the current collecting member 200 and may be bent toward one surface of the current collecting member 200 to have a short length.

In detail, in order to implement a secondary battery having high energy density and capacity, a plurality of electrode assemblies 100 may be stacked. As the number of stacked electrode assemblies 100 increases, a separation distance between the electrode tabs 110 may increase. Accordingly, in order to couple the electrode tabs 110 to each other, the length of the electrode tab 110 may increase. When the length of the electrode tab 110 increases, the area of the mixture layer in the current collector may decrease and the area of the uncoated portion in the current collector may increase during a manufacturing process of the electrode assembly structure 20 for a secondary battery, so that the energy density and capacity of the electrode assembly structure 20 for secondary batteries may decrease.

However, the electrode tab 110 of the electrode assembly structure 20 for a secondary battery according to an embodiment of the present disclosure may have a short length. Accordingly, during the manufacturing process of the electrode assembly structure 20 for a secondary battery, the area of the mixture layer in the current collector may increase and the area of the uncoated portion in the current collector may decrease. Therefore, the electrode assembly structure 20 for a secondary battery may have high energy density and capacity.

In the present disclosure, as illustrated in FIG. 3, the current collecting member 200 is not particularly limited as long as it includes two or more slits 210 with front and rear surfaces, through which the electrode tab 110 may pass, penetrated. One electrode tab 110 may pass through the slit 210, and two or more electrode tabs 110 may pass through the slit 210.

The two or more slits 210 formed in the electrode member may have the same size of the through-region through which the electrode tab 110 may pass, or may have different sizes.

In addition, the two or more slits 210 may be isolated from each other, and at least one of the two or more isolated slits 210 may have all four sides closed. Meanwhile, the two or more slits 210 may be isolated from each other, and at least one of the two or more isolated slits 210 may have at least one open side out of four sides. Accordingly, the two or more slits 210 may have all four sides closed, all slits 210 may have at least one side thereof open, and the slit 210 having at least one open side and the slit 210 having four sides closed may coexist.

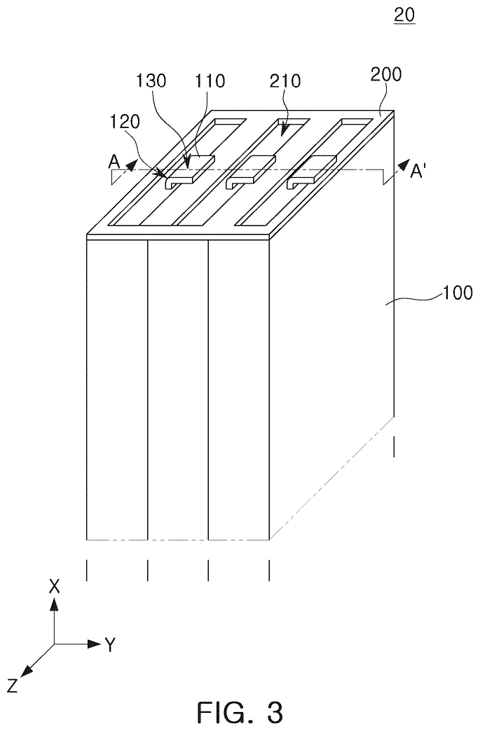

More specifically, FIGS. 5 to 8 illustrate examples of the current collecting member 200 according to an embodiment of the present disclosure. The current collecting member 200 of the present disclosure is not limited thereto, and those skilled in the art may understand that various modifications may be made from the configuration illustrated in FIGS. 5 to 8.

FIG. 5 is a plan view schematically illustrating an example of the current collecting member 200 in which a plurality of slits 210 formed in the current collecting member 200 are closed on all sides, according to an embodiment of the present disclosure. As illustrated in FIG. 5, the current collecting member 200 may include, for example, three slits 210, and the three slits 210 all have through-regions through which the electrode tabs 110 pass closed in all directions.

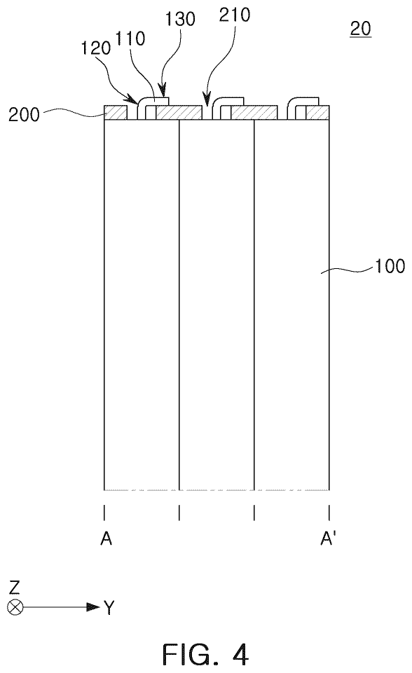

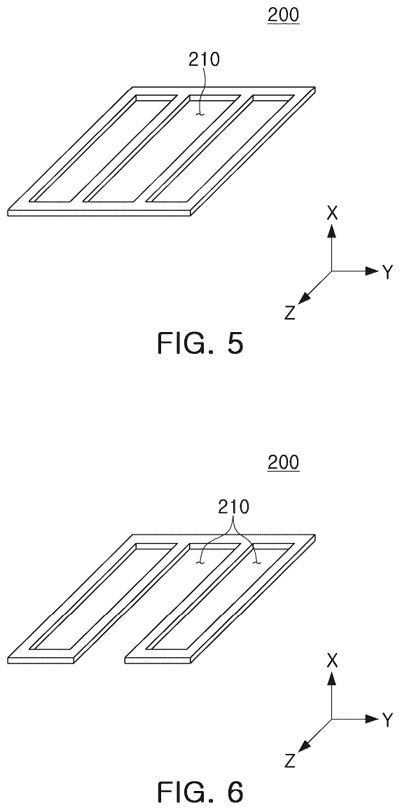

FIGS. 6 and 7 illustrate an example of the current collecting member 200 in which a plurality of slits 210 are isolated from each other and one of the two or more slits 210 includes a slit 210 with one open side.

Specifically, as illustrated in FIG. 6, two or more slits 210 are isolated from each other, and one side of the four sides surrounding the through-region through which the electrode tab 110 passes, that is, one surface of the slit 210 may be open.

Meanwhile, as illustrated in FIG. 7, the slit 210 located in the middle may be closed on all sides, and the two slits 210 (or one slit 210) located on both sides may be open to each other. At this time, the open side may be a side surface and may be either an upper surface or a lower surface, as illustrated in FIG. 6.

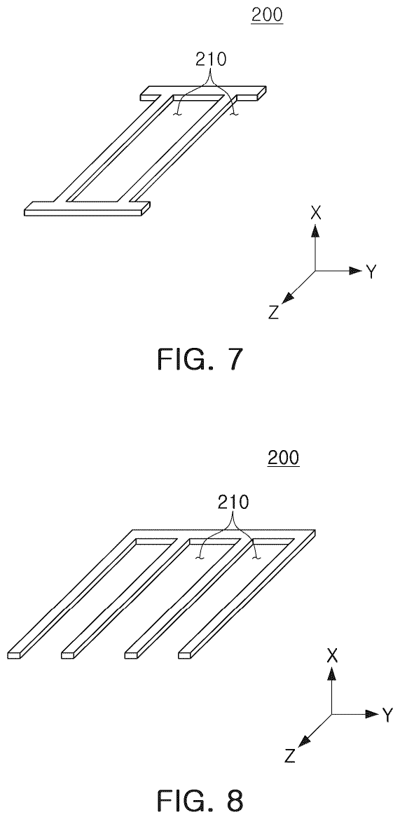

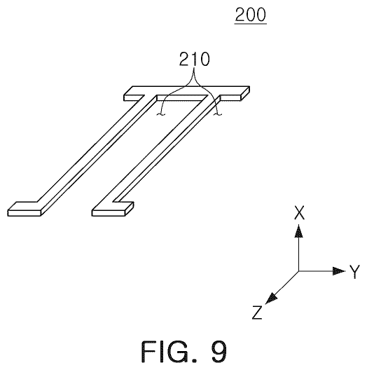

In the current collecting member 200 according to an embodiment of the present disclosure, a plurality of slits 210 formed in the current collecting member 200 may be isolated from each other, and all slits 210 may be open. Specifically, as illustrated in FIG. 8, the slit 210 may be open on the same one of the lower surface or the upper surface of the current collecting member 200, and although not illustrated, each slit 210 may be open on different sides among the upper surface and the lower surface. In addition, the current collecting member 200 may have different sides open. For example, as illustrated in FIG. 9, the slits 210 located on both sides may be open on the sides, and the middle slit may be open on an upper surface or lower surface.

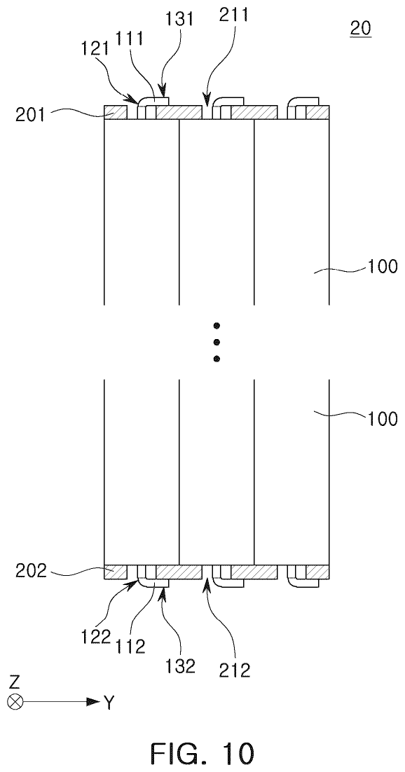

In the electrode assembly structure 20 for a secondary battery according to the present disclosure, an example in which the current collection member 200 is disposed at the first end portion of the electrode assembly stack 10, as illustrated in FIG. 3, is illustrated but is not limited thereto. Specifically, as illustrated in FIG. 10, the current collecting member 200 may be included in the first end portion and a second end portion of the electrode assembly stack 10.

For example, the electrode assembly stack 10 may further include a current collecting member 202 having polarity opposite to that of a current collecting member 201 on the second end portion, facing the first end portion. An example of the electrode assembly structure 20 for a secondary battery is schematically illustrated in FIG. 10. FIG. 10 is a cross-sectional view schematically illustrating an electrode assembly structure 20 for a secondary battery according to an embodiment of the present disclosure, in which the current collecting members 201 and 202 are disposed on both ends of the electrode assembly structure 20 for a secondary battery. As illustrated in FIG. 10, the electrode assembly structure 20 for a secondary battery may include positive and negative current collecting members 201 and 202 at both end portions, respectively.

Hereinafter, a secondary battery according to an embodiment of the present disclosure is described.

According to an embodiment, the secondary battery may include an electrode assembly structure 20 for a secondary battery according to any of the above embodiments and a battery case accommodating the electrode assembly structure 20.

The battery case may accommodate an electrode assembly structure 20 for a secondary battery.

In an embodiment, the battery case may have a concave internal space, and in this internal space, the electrode assembly structure 20 for a secondary battery may be accommodated, and further, an electrolyte solution, etc. may be stored.

The secondary battery may further include an electrode lead to be connected to a current collecting member of an electrode assembly structure for a secondary battery so as to be connected to an external device. The electrode lead may be bonded to a current collecting member inside the battery case by various methods, such as ultrasonic welding, and the electrode assembly structure 20 for a secondary battery inside the battery case may be connected to an external device through the electrode lead.

As described above, the electrode assembly structure 20 for a secondary battery may have high energy density and capacity. Accordingly, the energy density and capacity of the secondary battery may be improved.

According to an embodiment of the present disclosure, the energy density and capacity of a secondary battery may be improved.

While the present disclosure has been particularly illustrated and described with reference to exemplary embodiments thereof, it will be understood by those of ordinary skill in the art that various changes in form and details may be made therein without departing from the spirit and scope of the present disclosure as defined by the following claims.

The particular implementations illustrated and described herein are illustrative examples of the invention and are not intended to otherwise limit the scope of the invention in any way. Moreover, no item or component is essential to the practice of the invention unless the element is specifically described as “essential” or “critical.”

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the present disclosure.

What is claimed is:

1. An electrode assembly structure for a secondary battery, the electrode assembly structure comprising:
an electrode assembly stack in which two or more electrode assemblies with electrode tabs extending in one direction are stacked; and
a current collecting member disposed on a first end portion of the electrode assembly stack and including a slit through which the electrode tab passes,
wherein the electrode tab passes through the slit, and the electrode tab and the current collecting member are electrically connected.

2. The electrode assembly structure of claim 1, wherein the electrode tab is in contact with one surface of the current collecting member.

3. The electrode assembly structure of claim 1, wherein the electrode tab includes a bent portion bent toward one surface of the current collecting member.

4. The electrode assembly structure of claim 3, wherein the electrode tab is bent in a direction, perpendicular to an electrode tab extension direction.

5. The electrode assembly structure of claim 3, wherein the two or more electrode tabs are bent in the same direction.

6. The electrode assembly structure of claim 3, wherein the electrode tab is bent, and a distal end portion thereof contacts one surface of the current collecting member.

7. The electrode assembly structure of claim 1, wherein the one electrode tab passes through one slit.

8. The electrode assembly structure of claim 1, wherein the two or more slits are spaced apart from each other.

9. The electrode assembly structure of claim 8, wherein the two or more slits are isolated from each other, and at least one of the two or more slits is closed on all four sides.

10. The electrode assembly structure of claim 8, wherein the two or more slits are isolated from each other, and at least one of the slits has at least one side thereof open.

11. The electrode assembly structure of claim 1, wherein the electrode assembly stack is a stack of three or more electrode assemblies, the current collecting member has three or more slits, and one electrode tab passes through one slit.

12. The electrode assembly structure of claim 1, wherein the electrode tab has a length of 8 to 30 mm.

13. The electrode assembly structure of claim 1, wherein the electrode assembly stack further includes a current collecting member having a polarity opposite to a polarity of the current collecting member on a second end portion, facing the first end portion.

14. A secondary battery comprising:
the electrode assembly structure for a secondary battery according to claim 1; and
a battery case accommodating the electrode assembly structure.
